(19) United States
(12) Patent Application Publication
(10) Pub. No.: US 2006/0190888 A1
(43) Pub. Date: Aug. 24, 2006

(54) Apparatus and method for electronic device design

(75) Inventors: Bharadwaj Parthasarathy, Plano, TX (US); Sridhar Ramaswamy, Plano, TX (US); Paul E. Landman, Allen, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/047,204

(22) Filed: Jan. 31, 2005

(51) Int. Cl. G06F 17/50

(52) U.S. Cl. 716/8; 716/17

(57) ABSTRACT

A system and method is disclosed for computer-assisted transistor design. A new transistor design can be generated based on characteristics of an existing transistor. The system for transistor design receives a first set of parameters for an existing transistor design that are functions of a first geometry that is descriptive of the existing transistor design. Next, the system establishes a set of constraints for the new transistor to be designed. The system then calculates pertinent dimensions of a geometry for the new transistor design based on the constraints and the first set of parameters.

### TECHNICAL FIELD

This invention relates to a system and method for transistor design.

### BACKGROUND

Software products are commercially available that can be used for simulating circuit designs. A circuit designer can input information regarding the layout of a circuit and run a simulation. The simulation then provides the circuit designer with an idea of how a physical implementation of the circuit is likely to perform. If the circuit does not perform as desired, the circuit designer can change the layout of the circuit and run further simulations until desirable circuit function is achieved. This type of designing and testing is more efficient than building and testing physical test circuits, so the use of computers and software for circuit design has become commonplace.

Software products have also been proposed that can be used for simulating the operation of electronic component designs. A designer can provide the software with physical characteristics of an electronic device, and the software then simulates the operation of the device. The simulation can provide the device designer with operational characteristics of the device, allowing the designer to make changes to the physical structure of the device until desired operation has been achieved.

### SUMMARY

Prior systems and software products, such as those described above, are useful to a circuit or electronic device designer in that they allow ideas to be tested and improved before time and money is spent building an actual product. These systems still require, however, the time of a skilled designer who interprets the simulation results and makes changes to a device based on the simulation results in order to achieve desired performance.

The present disclosure presents a system and method for device design wherein a user can provide desired performance parameters and, in return, receive an indication of physical characteristics of a device that can achieve the desired performance parameters. For example, disclosed herein is a system and method for translating an existing design of one technology type to another technology type. An existing design for a transistor of one technology type can be translated to design a new transistor of another technology type.

### BRIEF DESCRIPTION OF THE DRAWINGS

Embodiments are illustrated by way of example in the accompanying figures, in which like reference numbers indicate similar parts, and in which:

FIG. 1 shows a block diagram of a computer system;

FIG. 2 shows a flowchart illustrating a prior approach to transistor design; and

FIG. 3 shows a flowchart of a new method of designing a transistor.

### DETAILED DESCRIPTION

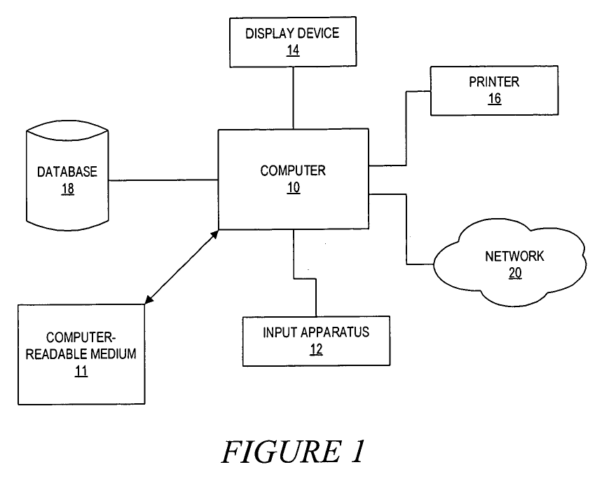

The present invention is directed to apparatuses and methods for a transistor design system. The transistor design system can comprise a software product executable by a computer system, for example as shown in FIG. 1. A computer 10 includes storage and processing capabilities for storing and running a software product stored on a computer-readable medium 11. A user can interact with the computer 10 via one or more input devices (collectively shown as an input apparatus 12) that can include, for example, a keyboard, a mouse, a stylus, or any other input device. Output from the computer 10 can be provided to the user via a display 14 and/or a printer 16. In some embodiments, data used by the computer 10 can be remotely stored on a database 18. The computer 10 can also be connected to other computers, servers, or other devices via a network 20, for example an intranet or the Internet. A user can run software described herein on the computer 10 from another device across the network 20 or using the input device 12. The computer 10 can retrieve data necessary for running software as described herein from data storage within the computer 10, from the database 18, or from another source across the network 20.

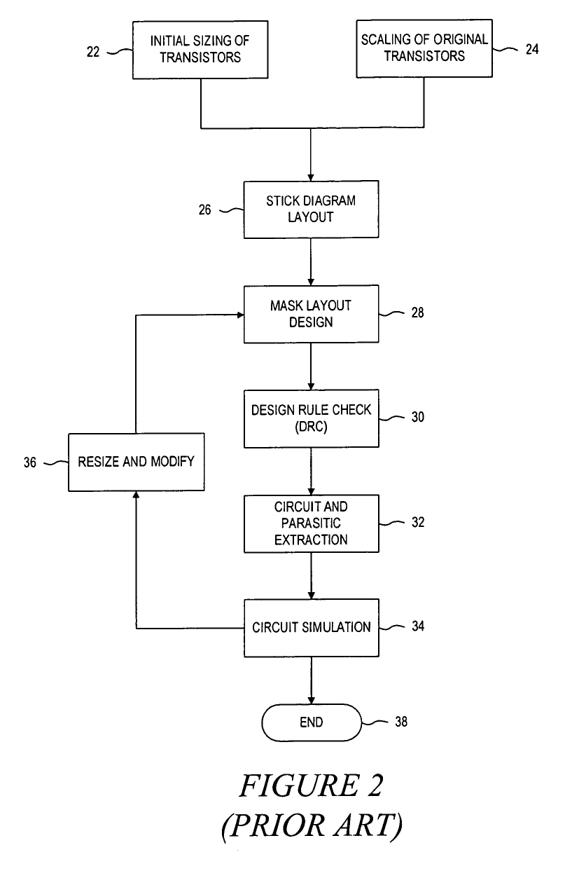

FIG. 2 shows a flowchart illustrating a prior approach to transistor design, for example as discussed in Integrated Systems Center & Microelectronics Group, Design of VLSI Systems chs. 2-3 (Y. Leblebici ed. Nov. 10, 1998), at http://www.vlsi.wpi.edu/webcourse/toc.html. This is an iterative approach commonly used for new designs, beginning at block 22, or for scaling of existing designs, beginning at block 24. For either scenario, at block 26 a designer creates a stick diagram layout in order to determine a feasible arrangement of circuit components. Then at block 28 a mask layout is drawn based on the stick diagram, then at block 30 the mask layout is checked to determine compliance with pertinent design rules. Performance of the circuit is then tested at block 32, where parasitic capacitances are estimated, and at block 34, where circuit operation is simulated to test for desired functionality and performance. If the circuit fails to operate within desired parameters, then at block 36 the circuit layout is modified, which usually includes modification of the channel length (L) and gate width (W) of one or more transistors of the circuit. Blocks 28 through 36 are repeated until the circuit, and devices that compose the circuit, operates within specified parameters.

The present disclosure presents a system and method for device design wherein a user can provide desired performance parameters and, in return, receive an indication of physical characteristics of a device that can achieve the desired performance parameters. For example, disclosed herein is a system and method for translating an existing design of one technology type to another technology type. An existing design for a transistor of one technology type can be translated to design a new transistor of another.

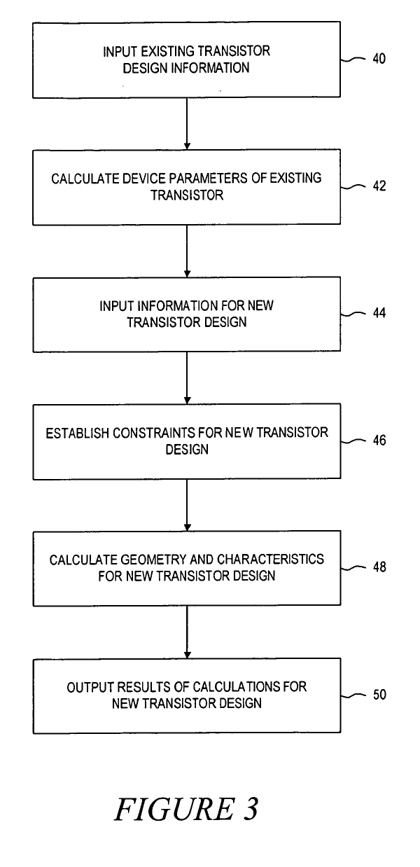

FIG. 3 shows a flowchart for an approach to electronic device design according to this method. This approach can be used for migrating an existing transistor design from one technology to another, including resealing of existing transistor designs from one technology node to another. A software product stored on the computer-readable medium 11 can be run on the computer 10 and can include instructions for designing a transistor according to the flowchart shown in FIG. 3. At block 40, the system inputs an existing transistor design. There are a number of ways in which this can be implemented. In some embodiments, a user might be presented with a list of existing transistor designs, the user can select a design from the list, and the system retrieves data associated with the selected design. For example, referring to the architecture shown in FIG. 1, the database 18 can include a library of existing transistors and characteristics associated with the transistors. In this scenario, a designer may desire to translate one of the transistor designs in the database 18 into a new design for a different technology node or family. Alternately, the system can receive data input from a user for an existing transistor design:

Next, at block 42, the system uses data received for the existing transistor design to calculate additional parameters related to the existing transistor. In some embodiments, block 42 can be optional since such additional parameters may have been previously calculated or otherwise obtained.

Next, at block 44, the system inputs information related to the new transistor design. This can include inputting information such as a technology node or family for the new transistor design, design rules for the new transistor design, and/or equations for calculating parameters of the new transistor design. At block 46, the system establishes constraints for the new transistor design. Constraints can include parameters or characteristics of the existing transistor design that should be implemented in the new transistor design.

Next, at block 48, the system calculates characteristics and parameters of the new transistor design. In some embodiments, this includes calculating a geometry of the new transistor design. The results of the calculations are output (e.g., provided to the user) at block 50.

The process in FIG. 2 will now be further explained by way of an example where a user wishes to migrate an existing design for an NMOS low Vₜ to a new design for an NMOS standard Vₜ having a substantially equal I_{d} (drain current) and Rₒᵤₜ (output resistance).

At block 40, the system establishes a particular existing transistor design to be used for the translation process. This can be accomplished in any of a number of ways, including allowing a user to select “NMOS low Vₜ” from a list of existing transistor designs, by receiving imported design or model data for the “NMOS low Vₜ”, or by allowing manual input of design data for “NMOS low Vₜ”.

Next, at block 42, the system calculates device parameters for the existing NMOS low Vₜ design. In this case, the design data includes information for the NMOS low Vₜ transistor including a channel length L=0.2 μm, a gate width W=25 μm, and terminal voltages V_{gs}=V_{ds}=1.2v (where V_{gs} is a gate-source voltage and V_{ds} is a drain-source voltage). The design data can also include equations for calculating other parameters of the transistor. For example, for the NMOS low Vₜ, drain current I_{d} can be calculated to be 16 mA according to equation (1) below, transconductance (Gₘ) can be calculated to be 21 mS according to equation (2) below, output resistance (Rₒ) can be calculated to be 692 ohms according to equation (3) below, and gate capacitance (C_{g}) can be calculated to be 37 fF according to equation (4) below.
I_{d}=f1(W,L,V_{gs}, V_{ds}) (1)
Gₘ=f2(W,L,V_{gs}, V_{ds})=d(f1)/d(V_{gs}) (2)
Rₒ=f3(W,L,V_{gs}, V_{ds})=d(f1)/d(V_{ds}) (3)
C_{g}=f4(W,L) (4)
More specifically, since the existing transistor design is an NMOS, the drain current I_{d} can be calculated according to equation (5) below.
I_{d}=(W/L)(K)(V_{gs}−Vₜ)² (5)
In equation (5), Vₜ is the threshold voltage, and K is a value that can be expressed according to equations (6) and (7) below.
K=(½)μₑCₒₓ (6)
Cₒₓ=εₒεᵣ/tₒₓ (7)
In equation (6), μₑ is the electron mobility and Cₒₓ is capacitance per unit area. In equation (7), εₒ is the permittivity constant (εₒ=8.85×10⁻¹² F/m), εᵣ is the relative permittivity (e.g., εᵣ=3.9 for SiO₂), tₒₓ is the gate-oxide thickness. In the present example, the calculations can result in I_{d}=16 mA, Gₘ=21 mS, Rₒ=692 ohms, and C_{g}=37 fF.

Next, at block 44, the system establishes a particular type of transistor (“NMOS standard Vₜ” in the present example) to which the previously-established existing transistor design (“NMOS low Vₜ” in the present example) will be translated. This can be accomplished in any of a number of ways, including allowing a user to select “NMOS standard Vₜ” from a list, by receiving imported data for the “NMOS standard Vₜ”, or by allowing manual input of data for “NMOS standard Vₜ”. Then, at block 46, the system establishes constraints related to the new transistor design. This can include design rules specific to the type of transistor to which the existing transistor design is being translated. This can also include allowing the designation of parameters of the existing transistor design that should be the same for the new transistor design. In the present example, the system can be instructed to match I_{d} and Rₒ (e.g., the new transistor should have I_{d}=16 mA and Rₒ=692 ohms).

Next, at block 48, the system can calculate device characteristics, for example device geometry, for the new transistor design. This can be accomplished by solving a series of equations based on Equations (1)-(4) above using a Taylor series expansion and the Newton-Raphson method. In the present example, such calculations can provide the following results: gate width W=42 μm, channel length L=0.3 μm, drain current I_{d}=16 mA, transconductance Gₘ=25 mS, output resistance Rₒ=692 ohms, and gate capacitance C_{g}=108 fF. These results are then output at block 50 via any type of one or more output devices (including a display).

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A method of designing a new transistor comprising:
receiving a first set of parameters for an existing transistor design that are functions of a first geometry that is descriptive of the existing transistor design;
establishing a set of constraints for the new transistor; and
calculating at least one dimension of a second geometry that is descriptive of the new transistor based on the constraints and the first set of parameters.

2. A method according to claim 1, wherein the first set of parameters include at least one of a drain current, a transconductance, an output resistance, and a gate capacitance.

3. A method according to claim 1, further comprising receiving equations for calculating a second set of parameters for the new transistor, wherein the second set of parameters are functions of a second geometry that is descriptive of the new transistor.

4. A method according to claim 3, wherein the calculating includes calculating the at least one dimension of the second geometry based on the equations, the constraints, and the first set of parameters.

5. A method according to claim 3, wherein the equations include an equation for calculating a drain current where the drain current is a function of at least one of a channel length, a gate width, a gate-source voltage, and a drain-source voltage.

6. A method according to claim 3, wherein the equations include an equation for calculating a transconductance where the transconductance is a function of at least one of a channel length, a gate width, a gate-source voltage, and a drain-source voltage.

7. A method according to claim 3, wherein the equations include an equation for calculating an output resistance where the output resistance is a function of at least one of a channel length, a gate width, a gate-source voltage, and a drain-source voltage.

8. A method according to claim 3, wherein the equations include an equation for calculating the gate capacitance where the gate capacitance is a function of at least one of a channel length, a gate width, a gate-source voltage, and a drain-source voltage.

9. A method according to claim 3, wherein the calculating includes linearizing the equations using a Taylor series expansion.

10. A method according to claim 3, wherein the calculating includes solving multiple ones of the equations simultaneously using the Newton-Raphson method.

11. A method according to claim 1, wherein the set of constraints includes a designation of at least one parameter of the first set of parameters to be equal to a corresponding parameter of the second set of parameters.

12. A method according to claim 1, wherein the first geometry includes at least one of a gate width and a gate length of the existing transistor design.

13. A computer program product comprising a computer-readable storage medium having instructions stored thereon for instructing at least one processor to perform operations of:
receiving a first set of parameters for an existing transistor design that are functions of a first geometry that is descriptive of the existing transistor design;
establishing a set of constraints for the new transistor; and
calculating at least one dimension of a second geometry that is descriptive of the new transistor based on the constraints and the first set of parameters.

14. A computer program product according to claim 13, wherein the first set of parameters include at least one of a drain current, a transconductance, an output resistance, and a gate capacitance.

15. A computer program product according to claim 13, further comprising receiving equations for calculating a second set of parameters for the new transistor, wherein the second set of parameters are functions of a second geometry that is descriptive of the new transistor.

16. A computer program product according to claim 15, wherein the calculating includes calculating the at least one dimension of the second geometry based on the equations, the constraints, and the first set of parameters.

17. A computer program product according to claim 15, wherein the equations include an equation for calculating a drain current where the drain current is a function of at least one of a channel length, a gate width, a gate-source voltage, and a drain-source voltage.

18. A computer program product according to claim 15, wherein the equations include an equation for calculating a transconductance where the transconductance is a function of at least one of a channel length, a gate width, a gate-source voltage, and a drain-source voltage.

19. A computer program product according to claim 15, wherein the equations include an equation for calculating an output resistance where the output resistance is a function of at least one of a channel length, a gate width, a gate-source voltage, and a drain-source voltage.

20. A computer program product according to claim 15, wherein the equations include an equation for calculating a gate capacitance where the gate capacitance is a function of at least one of a channel length, a gate width, a gate-source voltage, and a drain-source voltage.

21. A computer program product according to claim 15, wherein the calculating includes linearizing the equations using a Taylor series expansion.

22. A computer program product according to claim 15, wherein the calculating includes solving multiple ones of the equations simultaneously using the Newton-Raphson method.

23. A computer program product according to claim 13, wherein the set of constraints includes a designation of at least one parameter of the first set of parameters to be equal to a corresponding parameter of the second set of parameters.

24. A computer program product according to claim 13, wherein the first geometry includes at least one of a gate width and a gate length of the existing transistor design.
